(19) United States
(12) Patent Application Publication
(10) Pub. No.: US 2006/0101298 A1
(43) Pub. Date: May 11, 2006

(54) Wake-up system using oscillation

(75) Inventors: Tah Joon Park, Suwon (KR); Young Il Kwon, Suwon (KR); Joong Jin Kim, Suwon (KR)

Correspondence Address: VOLPE AND KOENIG, P.C., UNITED PLAZA, SUITE 1600, 30 SOUTH 17TH STREET, PHILADELPHIA, PA, 19103, US

(73) Assignee: Samsung Electro-Mechanics Co., Ltd., Suwon (KR)

(21) Appl. No.: 11/073,819

(22) Filed: Mar. 7, 2005

(30) Foreign Application Priority Data
Nov. 9, 2004 (KR) 10-2004-90664

(51) Int. Cl. G06F 1/26

(52) U.S. Cl. 713/323

(57) ABSTRACT

Disclosed is a wake-up system based on an oscillation principle adopted to wireless transmission/reception devices such as remote controllers, mobile communication terminals, etc. The wake-up system uses oscillation capable of performing a wake-up operation such that a receiver responds to a wake-up signal transmitted from a transmitter with a relatively low power, as an amplifying unit including an amplifier and a correlator is oscillated, in which the correlator is connected to the amplifier through a positive feedback loop and another correlator having the same structure as that of the receiver is applied to the transmitter.

### RELATED APPLICATION

The present application is based on, and claims priority from Korean Application Number 2004-90664, filed Nov. 9, 2004, the disclosure of which is incorporated by reference herein its entirety.

### BACKGROUND OF THE INVENTION

1. Field of the Invention

The present invention relates to a wake-up system adopted to wireless transmission/reception devices such as remote controllers, mobile communication terminals, etc., and more particularly to a wake-up system using oscillation capable of performing a wake-up operation such that a receiver responds to a wake-up signal transmitted from a transmitter with a relatively low power, as an amplifying unit including an amplifier and a correlator is oscillated, in which the correlator is connected to the amplifier through a positive feedback loop and another correlator having the same structure as that of the receiver is applied to the transmitter.

2. Description of the Related Art

Generally, with increase of utility of wireless access communication, a connection network of a type of wired and wireless integrating system is constructed in various fields and thusly there has arisen a demand for a technical standard for low speed, low-priced and low-power wireless communication.

One of low power operating methods is to operate a system in a power saving mode wherein the system in a sleep mode is awakened according to a wake-up signal. In order to wake-up according to a wake-up signal, a system should periodically operate and check whether the wake-up signal is received. Also, if the wake-up signal is received, the system should further confirm whether the wake-up signal corresponds to a signal to activate itself.

As such, in order to perform a confirmation operation of the system wake-up, since a plurality of active elements and circuits should be operated, the system requests relatively high power, which should be reduced.

With reference to FIG. 1, one of the wake-up systems of a wireless transmission/reception device is described in detail below.

FIG. 1 is a construction view illustrating a wake-up system of a wireless transmission/reception device according to the prior art.

As shown in FIG. 1, the wake-up system includes a transmission controlling unit 10 for controlling wake-up of a receiver, a transmission processing unit 20 for generating and transmitting a wake-up signal according to the control of the transmission controlling unit 10, a reception controlling unit 40 for confirming whether its own wake-up signal is received by repeatedly performing conversion operations between a sleep mode and a standby mode, and controlling a wake-up operation of the system if the received wake-up signal is determined to be a signal corresponding to activate itself, and a reception processing unit 30 for receiving and processing a receiving signal according to the control of the reception controlling unit 40 and providing the processed signal to the reception controlling unit 40.

In a wake-up operation of such a wireless transmission/reception device, when the transmission controlling unit 10 controls transmission of a wake-up signal, the transmission processing unit 20 generates the wake-up signal and transmits it through the air.

Here, when the reception controlling unit 40 is changed from sleeping mode to standby mode to control confirmation of a wake-up signal, a signal received by the reception processing unit 30 is amplified, filtered and decoded. After that, it is confirmed whether the received signal corresponds to its own wake-up signal. If the received signal is its own wake-up signal, the reception controlling unit 40 is awakened. Meanwhile if it is not, the reception controlling unit 40 is changed from standby mode to sleep mode.

As such, the wake-up system of the wireless transmission/reception device according to the prior art consumes relatively high power to be waken-up as active elements or circuits such as a mixer or an oscillator must be operated to process received signals based on signal processes such as decoding etc.

### SUMMARY OF THE INVENTION

Therefore, the present invention has been made in view of the above problems, and it is an object of the present invention to provide a wake-up system using oscillation capable of performing a wake-up operation such that a receiver responds to a wake-up signal transmitted from a transmitter with a relatively low power, as an amplifying unit including an amplifier and a correlator is oscillated, in which the correlator is connected to the amplifier through a positive feedback loop and another correlator having the same structure as that of the receiver is applied to the transmitter.

In accordance with the present invention, the above and other objects can be accomplished by the provision of a wake-up system using oscillation comprising: a) a transmitter, including: a wake-up signal generation unit for generating wake-up signals; a first passive correlator for correlating and coding the wake-up signals to generate coded signals; and a transmission antenna for wirelessly transmitting the coded signals to the air; and b) a receiver, including: a reception antenna for receiving the coded signals transmitted from the transmission antenna; a power supply for supplying first and second powers; an amplifying unit including: an amplifier for being supplied with the second power and amplifying the coded signals from the reception antenna; and a second passive correlator for correlating and decoding the amplified signal from the amplifier and positively feeding back the decoded signals to the amplifier, wherein the second passive correlator is structurally matched with the first passive correlator; an AC/DC converting unit for converting the output signals from the amplifying unit into DC switching voltage signals; and a wake-up switching unit for performing an ON/OFF switching operation according to the DC switching voltage signals and outputting the first power as a wake-up voltage thereto based on the result of the switching operation.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a construction view illustrating a wake-up system of a wireless transmission/reception device according to the prior art;

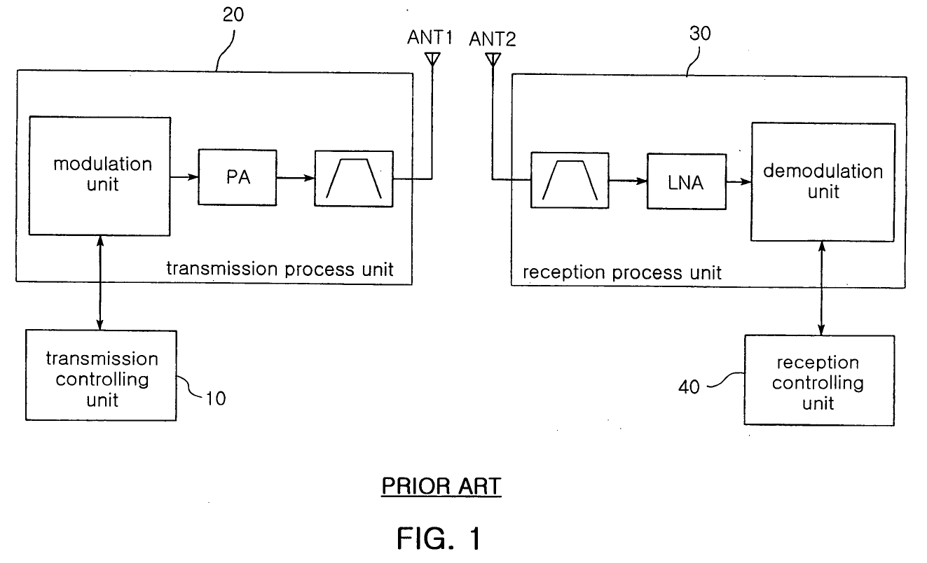

FIG. 2 is a construction view illustrating a wake-up system according to the present invention;

FIG. 3 is a construction view illustrating a first passive correlator according to the present invention;

FIG. 4 is a construction view illustrating an amplifier including a second correlator according to the present invention;

FIG. 5 is a schematic block diagram describing oscillation operations of the amplifier of FIG. 4; and

FIGS. 6a to FIG. 6c are voltage waveforms of received signals according to the present invention.

### DESCRIPTION OF THE PREFERRED EMBODIMENTS

With reference to the attached drawings, the preferred embodiments of the present invention are described in detail below.

In the description, elements having substantially the same configuration and functions are denoted by identical reference numeral.

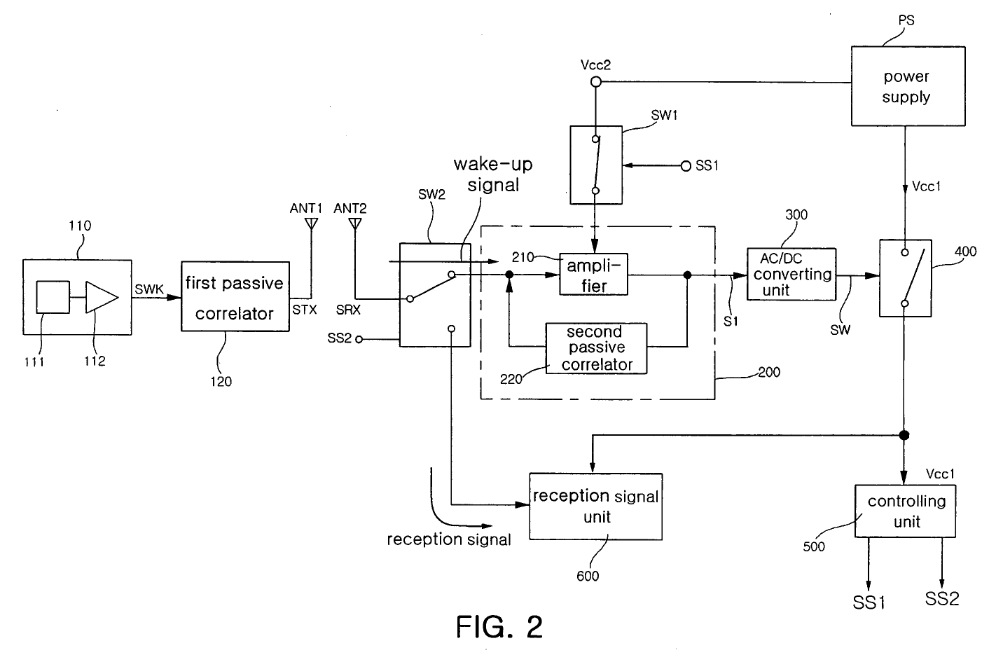

FIG. 2 is a construction view illustrating a wake-up system according to the present invention.

As shown in FIG. 2, the wake-us system comprises a transmitter and a receiver. The transmitter includes a wake-up signal generation unit 110 for generating wake-up signals SWK, a first passive correlator 120 for correlating and coding the wake-up signals SWK to generate coded signals and a transmission antenna ANT1 for wirelessly transmitting the coded signals for transmission through the air, which is referred to as a coded transmission signal STX.

The receiver includes a reception antenna ANT2 for receiving signals transmitted from the transmission antenna ANT1, a power supply PS for supplying first power Vcc1 and second power Vcc2, and an amplifying unit 200. Here, the amplifying unit 200 includes an amplifier 210 supplied with the second power Vcc2 and amplifying the received signals from the reception antenna ANT2 and a second passive correlator 220 for correlating and decoding output signals from the amplifier 210 and positively feeding back the output signals to the amplifier 210, wherein the second passive correlator 220 is structurally matched with the first passive correlator 120. Also, the receiver includes an AC/DC converting unit 300 for converting the output signals from the amplifying unit 200 into DC switching voltage signals VSW and a wake-up switching unit 400 for performing an ON/OFF switching operation according to the DC switching voltage signals VSW and outputting the first power Vcc1 as a wake-up voltage thereto based on the result of the switching operation.

Here, the receiver of the wake-up system further includes a controlling unit 500 for generating first and second witching signals SS1 and SS2 to be supplied therewith if the controlling unit 400 receives the first power Vcc1 through the wake-up switching unit 400, a first switch SW1 for interrupting the second power Vcc2 from the power supply PS to the amplifying unit 200 according to the first switching signal SS1 from the controlling unit 500 and a second switch SW2 for connecting the reception antenna ANT2 to a received signal processing unit 600 according to the second switching signal SS2 from the controlling unit, wherein the second switch SW2 electrically connects the reception antenna ANT2 to the amplifying unit 200 in a normal state.

Here, the wake-up signal generation unit 110 includes a signal generation unit 111 for generating the wake-up signals; and a power amplifier 112 for amplifying power of the wake-up signals for transmission.

Here, the first and second passive correlators 120 and 220 are implemented with passive elements capable of coding or decoding signals and performing correlation thereof, such as a Film Bulk Acoustic Resonator (FBAR), an FBAR filter and a matched SAW filter as well.

The embodiment of the present invention employing the first and second passive correlators 120 and 220 implemented with a SAW filter is described in detail below.

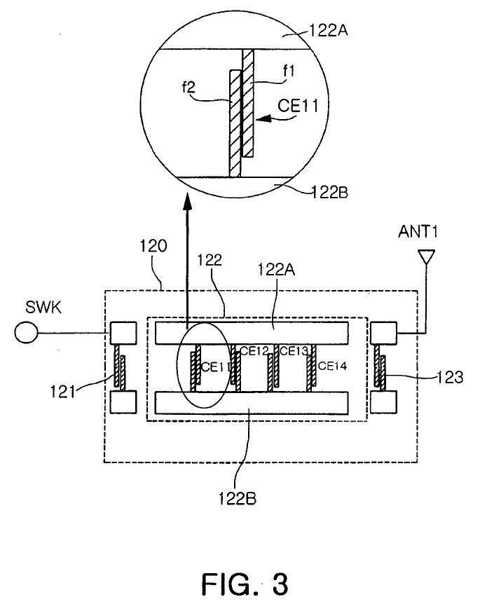

FIG. 3 is a construction view illustrating a first passive correlator according to the present invention.

As shown in FIG. 3, the first passive correlator 120 comprises a matched SAW filter formed on a piezoelectric plate. Here, the matched SAW filter includes a SAW input electrode unit 121 for converting the wake-up signals SWK from the wake-up signal generation unit 110 into SAW signals, a coding electrode unit 122 for correlating and coding the SAW signals from the SAW input electrode unit 121 and a SAW output electrode unit 123 for converting the SAW signals from the coding electrode unit 122 into electrical signals to be outputted to the transmission antenna ANT1.

Here, the coding electrode unit 122 includes a first electrode 122A formed in a conductive linear pattern on the piezoelectric plate, a second electrode 122B formed in a conductive pattern, the second electrode 122B being spaced from the first electrode 122A by a predetermined interval and parallel to the first electrode 122A and a plurality of coding electrodes CE11˜CE14. The plurality of coding electrodes CE11˜CE14 includes a plurality of first electrode fingers f1 formed in a conductive pattern formed in the direction of the second electrode 122B, the plurality of first electrode fingers f1 are connected to the first electrode 122A and a plurality of second electrode fingers f2 formed in a conductive pattern formed in the direction of the first electrode 122A, the plurality of second electrode fingers f2 are connected to the second electrode 122B. Here, the first and second electrode fingers f1 and f2 are interwoven with each other to form the teeth of a comb structure, and the first and second electrode fingers f1 and f2 are corresponded, respectively, to form a pair.

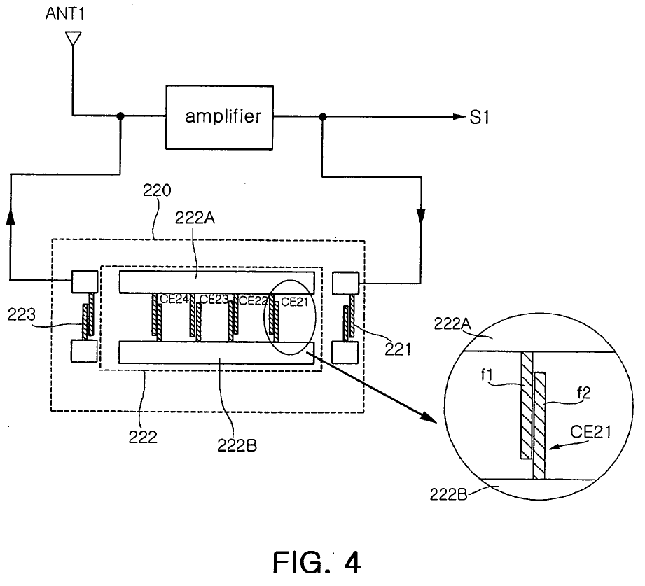

FIG. 4 is a construction view illustrating an amplifier including a second correlator according to the present invention.

As shown in FIG. 4, the amplifying unit 200 as mentioned above includes the amplifier 210 and the second passive correlator 220. The second passive correlator 220 forms an oscillation condition together with the amplifier 210 if a wake-up signal is transmitted from the transmitter having a first passive correlator 120. Here, the second passive correlator 220 has the same structure as that of the first passive correlator 120 and performs the same function as that of the first passive correlator 120.

Here, the second passive correlator 220 comprises a matched SAW filter formed on the piezoelectric plate. The matched SAW filter includes a SAW input electrode 221 for converting the output signal from the amplifier 210 into a SAW signal, a decoding electrode 222 for correlating and decoding the SAW signal from the SAW input electrode 221, wherein the correlating operation is identical to that of the coding electrode 122 and a SAW output electrode 223 for converting the SAW signal from the coding electrode 222 into an electrical signal and positively feeding back the electrical signal to the amplifier 210.

Here, the decoding electrode unit 222 includes a first electrode 222A formed in a conductive linear pattern on the piezoelectric plate, a second electrode 222B formed in a conductive pattern, the second electrode 222B being spaced from the first electrode 222A with a predetermined interval and parallel to the first electrode 222A and a plurality of decoding electrodes CE21˜CE24. The plurality of decoding electrodes CE21˜CE24 includes a plurality of first electrode fingers f1 formed in a conductive pattern formed in the direction of the second electrode 222B, the plurality of first electrode fingers f1 being connected to the first electrode 222A and a plurality of second electrode fingers f2 formed in a conductive pattern formed in the direction of the first electrode 222A, the plurality of second electrode fingers f2 being connected to the second electrode 222B. Here, the first and second electrode fingers f1 and f2 are interwoven with each other to form the teeth of a comb structure, and the first and second electrode fingers f1 and f2 are corresponded, respectively, to form a pair.

Here, the plurality of decoding electrodes CE21˜CE24 of the decoding electrode unit 222 are identically aligned like the plurality of coding electrodes CE11˜CE14 of the coding electrode unit 122.

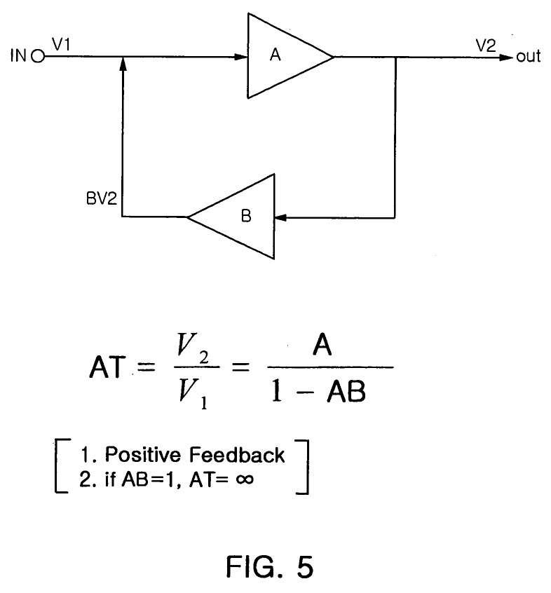

FIG. 5 is a schematic block diagram describing oscillation operations of the amplifier of FIG. 4.

As shown in FIG. 5, under the assumption that the amplifier 210 of the amplifying unit 200 has a gain of A and the second passive correlator 220 of the amplifying unit 200 has a gain of B, when the amplifying unit 200 inputs an input signal SRX at a voltage V1 and outputs an output signal S1 at a voltage V2, the total gain AT is obtained as V2/V1=A/(1−AB). Here, it is appreciated that the oscillation condition is AB=1.

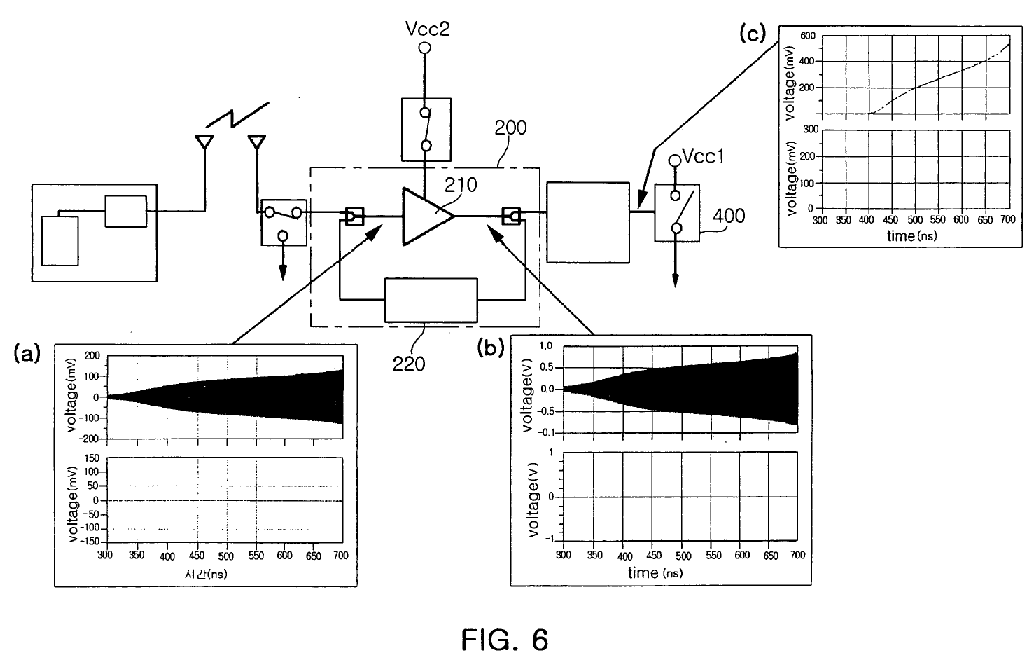

FIGS. 6a to 6c are voltage waveforms of received signals according to the present invention.

More specifically, FIG. 6a is graphs of positive feedback input signals of the amplifier 210, in which the upper graph is of a positive feedback signal when the first and second correlators are correlated to each other, and the lower graph is of a positive feedback signal when the first and second correlators are not correlated to each other.

FIG. 6b is graphs of output signals of the amplifier 210, in which the upper graph is of an output signal when the first and second correlators are correlated to each other, and the lower graph is of an output signal when the first and second correlators are not correlated to each other.

FIG. 6c is a graph of an output signal of the AC/DC converting unit 300, in which the upper graph is of an output signal when the first and second correlators are correlated to each other, and the lower graph is of an output signal when the first and second correlators are not correlated to each other.

The operations and effects of the present invention are described in detail as follows with reference to the drawings.

Referring to FIG. 2, a wake-up signal SWK is generated in the wake-up signal generation unit 110 of the transmitter. The wake-up signal SWK may be a signal pulse signal of pulse train having a plurality of pulses.

Also, the signal generation unit 111 of the wake-up signal generation unit 110 produces a wake-up signal whose power is amplified by the power amplifier 112 for transmission.

Referring to FIGS, 2 and 3, the wake-up signals SWK are correlated and coded in the first passive correlator 120 for transmission, which is referred to as a coded transmission signal STX. The coded transmission signal STX is transmitted through the air through the antenna in a wireless manner.

Here, since the wake-up signals are coded in the first passive correlator 120, the coded signals can be decoded to retrieve the wake-up signals by a correlator of the receiver having the same structure as that of the first passive correlator 120.

Wake-up operations of the receiver receiving wake-up signals transmitted from the transmitter are described in detail below.

Referring to FIGS. 2 and 4, a transmitted signal from the transmission antenna ANT1 is received through the reception antenna ANT2. The amplifying unit 200 including the amplifier 210 and the second correlator 220 performs oscillation based on the received signal from the antenna ANT2. In order to perform the oscillation operation in the amplifying unit 200, the second passive correlator 220 must be structurally and functionally matched to the first passive correlator 120 of the transmitter.

Here, the amplifying unit 200 amplifies the received signal SRX transmitted from the transmitter applied with a matched correlator to have power thereof performing a wake-up operation.

More specifically, the amplifier 210 of the amplifying unit 200 is supplied with second power Vcc2 from the power supply PS and amplifies the received signal from the reception antenna ANT2. At the same time, the second passive correlator 220 of the amplifying unit 200 correlates and decodes the output signals from the amplifier 210 and then positively feeds back the result of the correlation and decoding to the amplifier 210.

For example, when the first and second passive correlators 120 and 220 are structurally matched to each other, the second passive correlator 220 can normally decode the coded signal of the first passive correlator 120 as shown in the upper graph of FIG. 6a. Therefore, the amplifying unit 200 performs an oscillation operation and amplifies the received signal into a signal, as shown in the upper graph of FIG. 6b, capable of sufficiently performing a wake-up operation to output it thereto.

Meanwhile, when the first and second passive correlators 120 and 220 are not structurally matched to each other, the second passive correlator 220 cannot normally decode the coded signal of the first passive correlator 120 as shown in the lower graph of FIG. 6a. Therefore, since the amplifying unit 200 cannot perform an oscillation operation, the received signal is not amplified as shown in the lower graph of FIG. 6b.

Oscillation operations of the amplifying unit 200 are described in detail below with reference to FIG. 5.

Referring to FIG. 5, under the assumption that the amplifier 210 of the amplifying unit 200 has a gain of A and the second passive correlator 220 has a gain of B, when the amplifying unit 200 inputs an input signal SRX at a voltage V1 and outputs an output signal S1 at a voltage V2, the total gain AT of the amplifying unit 200 is obtained by the following equation (1).

$$AT = \frac{V 2}{V 1} = \frac{A}{1 - AB} \qquad ( 1 )$$

where oscillation occurs when AB=1.

As shown in equation 1, the amplifying unit 200 satisfying the oscillation condition amplifies the input signal SRX to have power capable of sufficiently performing a wake-up operation and outputs it thereto.

For example, when A is 0.5 and the first and second passive correlators 120 and 220 are structurally matched to each other, if B is (1/0.5), then the total gain of the amplifying unit 200 is theoretically infinite according to equation (1). Therefore, the amplifying unit 200 is oscillated. In this state, since the gain of the amplifier 210 is relatively small, it is appreciated that power consumption is small too.

Meanwhile, when A is 0.5 and the first and second passive correlators 120 and 220 are not structurally matched to each other, if B is almost zero, then the total gain of the amplifying unit 200 is approximately one according to equation (1). Therefore, the amplifying unit 200 as a buffer is not oscillated.

If the first and second passive correlators 120 and 220 are matched to each other, the AC/DC converting unit 300 converts an output signal from the amplifying unit 200 into a DC switching voltage VSW for a wake-up operation as shown in the upper graph of FIG. 6c. Here, the DC switching voltage VSW is supplied to a wake-up switching unit 400, which will be described later.

Meanwhile, if the first and second passive correlators 120 and 220 are not matched, the output voltage of the AC/DC converting unit 300 is approximately zero as shown in the lower graph of FIG. 6c.

The wake-up switching unit 400 performs switching operation of first power Vcc1 from the power supply PS according to the DC switching voltage VSW from the AC/DC converting unit 300.

With reference to FIGS. 2 to 4, the first and second passive correlators 120 and 220 are described in detail below.

Referring to FIGS. 2 and 3, in the first passive correlator 120, the wake-up signal SWK from the wake-up signal generation unit 110 is converted into a SAW signal by a SAW input electrode 121. The SAW signals from the SW input electrode unit 121 are correlated and coded in the code electrode unit 122. After that, the SAW signal from the electrode unit 122 is converted into an electrical signal by the SAW output electrode unit 12.3 to output it through the transmission antenna ANT1.

The coding procedure of the first passive correlator 120 is described below. Signals inputted to the first correlator 120 are coded according to the structure of the matched SAW filter. The coding operation is differently performed in a plurality of electrode pairs included in code electrodes of the code electrode unit 122. Namely, the coding operation is performed according to alignment sequences of a plurality of first and second electrode fingers. Here, the plurality of first electrode fingers f1 are connected to the first electrode 122A and formed in a conductive pattern formed in the direction of the second electrode 122B, and the plurality of second electrode fingers f2 are connected to the second electrode 122B and formed in a conductive pattern formed in the direction of the first electrode 122A.

For example, if “0” is defined to mean that the second electrode finger f2 is aligned after the first electrode f1 and if “1” is defined to mean the opposite, the coding electrode unit 122 of FIG. 3 performs coding operations such as “0, 1, 0, 0.”

Referring to FIGS. 2 and 4, in the second passive correlator 220, the output signal from the amplifier 210 is converted into a SAW signal by the SAW input electrode 221. The SAW signal is decoded in the decoding electrode unit 222 while the decoding electrode unit 222 performs the same correlation operation as that of the coding electrode unit 122. After that, the SAW signal from the coding electrode 222 is converted into an electrical signal by the SAW output electrode unit 223.

Meanwhile, decoding procedure of the second passive correlator 220 is described below. Signals inputted to the second correlator 220 are decoded according to the structure of the matched SAW filter. The decoding operation is differently performed in a plurality of electrode pairs included in decode electrodes of the decode electrode unit 222. Namely, the decoding operation is performed according to alignment sequences of a plurality of first and second electrode fingers of each electrode pair. Here, the plurality of first electrode fingers f1 are connected to the first electrode 222A and formed in a conductive pattern formed in the direction of the second electrode 222B, and the plurality of second electrode fingers f2 are connected to the second electrode 222B and formed in a conductive pattern formed in the direction of the first electrode 222A.

For example, if “1” is defined to mean that the second electrode finger f2 is aligned after the first electrode f1 and if “0” is defined to mean the opposite, the decoding electrode unit 122 of FIG. 4 performs decoding operations such as “0, 1, 0, 0,” which is matched to the coding operation of the coding electrode unit 122 of the first passive correlator 120.

As apparent from the above description, in the wake-up system of the present invention, a decoding operation of the receiver is performed to match the coding operation of the transmitter. The decoded signal is satisfied with the oscillation condition of the amplifier such that the amplifying unit 200 outputs a signal having sufficient power to be switched to perform a wake-up operation. Such a signal having power satisfying the conditions is converted into a DC switching voltage VSW such that the switching unit is turned on to supply power to the receiver. Therefore, the receiver is awakened.

Also, the controlling unit 500 of the present invention supplies first and second switching signals SS1 and SS2 to the first and second switches, respectively, if the first power Vcc1 is supplied therewith. Therefore, the first switch SW1 performs disconnection of the second power Vcc2 from the power supply PS to the amplifying unit 200 according to the first switching signal SW1, thereby stopping the operation of the amplifying unit 200.

The second switch SW2 electrically connects the reception antenna ANT2 to the amplifying unit 200 in a normal state. However, the second switch SW2 switches the normal state to a state such that the reception antenna ANT2 is electrically connected to a received-signal processing unit 600 according to the second switching signal SS2 from the controlling unit 500. Therefore, the output signal from the reception antenna ANT2 is processed in the received-signal processing unit 600.

As mentioned above, the wake-up system according to the present invention can perform a wake-up operation using the correlators each of which is adopted to the transmitter and receiver and matched to each other even if the amplification rate of the amplifier is not increased, thereby reducing consumption power for a wake-up operation.

The present invention relates to a wake-up system adopted to wireless transmission/reception devices such as remote controllers, mobile communication terminals, etc., and more particularly to a wake-up system using oscillation capable of performing a wake-up operation such that a receiver responds to a wake-up signal transmitted from a transmitter with a relatively low power, as an amplifying unit including an amplifier and a correlator is oscillated, in which the correlator is connected to the amplifier through a positive feedback loop and another correlator having the same structure as that of the receiver is applied to the transmitter.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A wake-up system using oscillation comprising:
a) a transmitter, including:
a wake-up signal generation unit for generating wake-up signals;
a first passive correlator for correlating and coding the wake-up signals to generate coded signals; and
a transmission antenna for wirelessly transmitting the coded signals to the air; and
b) a receiver, including:
a reception antenna for receiving the coded signals transmitted from the transmission antenna;
a power supply for supplying first and second powers;
an amplifying unit including:
an amplifier for being supplied with the second power and amplifying the coded signals from the reception antenna; and
a second passive correlator for correlating and decoding the amplified signal from the amplifier and positively feeding back the decoded signals to the amplifier, wherein the second passive correlator is structurally matched with the first passive correlator;
an AC/DC converting unit for converting the output signals from the amplifying unit into DC switching voltage signals; and
a wake-up switching unit for performing an ON/OFF switching operation according to the DC switching voltage signals and outputting the first power as a wake-up voltage thereto based on the result of the switching operation.

2. The system as set forth in claim 1, wherein the receiver further includes:
a controlling unit for generating a first and second switching signals to be supplied therewith if the controlling unit receives the first power through the wake-up switching unit;
a first switch for performing a disconnecting operation of the second power from the power supply to the amplifying unit according to the first switching signal from the controlling unit; and
a second switch for connecting the reception antenna to a received signal processing unit according to the second switching signal from the controlling unit, wherein the second switch electrically connects the reception antenna to the amplifying unit in a normal state.

3. The system as set forth in claim 1, wherein the wake-up signal generation unit includes:
a signal generation unit for generating the wake-up signals; and
a power amplifier for amplifying power of the wake-up signals for transmission.

4. The system as set forth in claim 1, wherein the first passive correlator comprises a matched SAW filter formed on a piezoelectric plate, in which the matched SAW filter includes:
a SAW input electrode unit for converting the wake-up signals into SAW signals;
a coding electrode unit for correlating and coding the SAW signals; and
a SAW output electrode unit for converting the SAW signals into electrical signals to be outputted to the transmission antenna.

5. The system as set forth in claim 4, wherein the coding electrode unit includes:
a first electrode formed in a conductive linear pattern on the piezoelectric plate;
a second electrode formed in a conductive pattern, the second electrode being spaced from the first electrode with a predetermined interval and parallel to the first electrode; and
a plurality of coding electrodes including:
a plurality of first electrode fingers formed in a conductive pattern formed in the direction of the second electrode, the plurality of first electrode fingers are connected to the first electrode; and
a plurality of second electrode fingers formed in a conductive pattern formed in the direction of the first electrode, the plurality of second electrode fingers are connected to the second electrode,
wherein the first and second electrode fingers are interwoven with each other to form the teeth of a comb structure, and the first and second electrode fingers are corresponded, respectively, to form a pair.

6. The system as set forth in claim 1, wherein the second passive correlator comprises a matched SAW filter formed on a piezoelectric plate, in which the matched SAW filter includes:
a SAW input electrode for converting the coded signals received by the reception antenna into a SAW signal;
a decoding electrode for correlating and decoding the SAW signal from the SAW input electrode, wherein the correlating operation is identical to that of the coding electrode; and
a SAW output electrode for converting the SAW signal from the coding electrode into an electrical signal and outputting it thereto.

7. The system as set forth in claim 6, wherein the decoding electrode unit includes:
a first electrode formed in a conductive linear pattern on the piezoelectric plate;
a second electrode formed in a conductive pattern, the second electrode being spaced from the first electrode with a predetermined interval and parallel to the first electrode; and
a plurality of decoding electrodes including:
a plurality of first electrode fingers formed in a conductive pattern formed in the direction of the second electrode, the plurality of first electrode fingers being connected to the first electrode; and
a plurality of second electrode fingers formed in a conductive pattern formed in the direction of the first electrode, the plurality of second electrode fingers being connected to the second electrode,
wherein the first and second electrode fingers are interwoven with each other to form the teeth of a comb structure, and the first and second electrode fingers are corresponded, respectively, to form a pair.

8. The system as set forth in claim 1, wherein the plurality of decoding electrodes of the decoding electrode unit are identically aligned like the plurality of coding electrodes of the coding electrode unit.
